(19) United States
(12) Patent Application Publication
(10) Pub. No.: US 2020/0282601 A1
(43) Pub. Date: Sep. 10, 2020

(54) METHOD AND DEVICE FOR THERMAL ROUNDING OR SPHERONISATION OF POWDERED PLASTIC PARTICLES

(71) Applicant: DRESSLER GROUP GMBH & CO. KG, Meckenheim (DE)

(72) Inventor: Axel DRESSLER, Alfter (DE)

(21) Appl. No.: 16/645,616

(22) PCT Filed: Aug. 28, 2018
(86) PCT No.: PCT/EP2018/073137

§ 371 Date: Mar. 9, 2020

(30) Foreign Application Priority Data
Sep. 12, 2017 (DE) 10 2017 121 048.2

(51) Int. Cl. B29B 9/16; B01J 2/16

(52) U.S. Cl. CPC B29B 9/16; B33Y 40/10; B29B 2009/166; B01J 2/16

(57) ABSTRACT

A method for shaping a starting material of powdered plastic particles includes the following steps: a) providing powdered plastic particles as a starting material; b) heating the plastic particles in a first treatment space to a first temperature below the melting point of the plastic, the first temperature being determined such that the plastic particles do not yet stick to one another; c) transferring a directed current of the plastic particles thus heated into a second treatment space; d) heating the plastic particles in the second treatment space to a second temperature above the melting point of the plastic; and e) cooling the plastic particles to a temperature below the first temperature.

### TECHNICAL FIELD

A method and a device for forming pulverulent plastics into pulverulent plastics that are as spherical as possible

The disclosure relates to a method and a device for converting pulverulent plastics into pulverulent plastics that are as spherical as possible. In other words, it describes a method and a device for rounding powder. Starting with particles of any shape, they are to be brought into as spherical a shape as possible. The disclosure thus starts with a pulverulent material, hereinafter referred to as a starting material, which is already provided, but is not provided in as spherical a shape as possible. This material is treated in such a way that the individual particles are as spherical as possible, i.e. significantly rounder than the particles of the starting material. In the process, the volume of the particles of the starting material is supposed to be substantially maintained, e.g. at least 90% thereof. The mass of the particles is to be maintained as much as possible, e.g. at least 90% thereof. The individual particles are only reshaped. The chemical composition is to remain unchanged as far as possible by the reshaping.

### BACKGROUND

Industry requires pulverulent plastics that are provided as spherical as possible. Given an ideal spherical shape of the individual particles, a product is known to have a particularly high density and a good flowability or fluidity, which is not provided in this way in the case of an irregular shape of the particles. The pulverulent plastics treated in accordance with the disclosure are supposed to be capable of being used, for example, for powder sintering, 3D printing, 3D melting and 3D sintering.

Methods and devices are known for melting and spraying, by means of a nozzle, plastics that are provided in a larger initial shape, e.g. as bars or granules. In this regard, reference is made to EP 945 173 B1, WO 2004/067245 A1 and U.S. Pat. No. 6,903,065 B2. However, these methods and devices require considerable effort. It is easier to mechanically crush such plastics in special grinders or other suitable devices. In that case, however, the shape of the particles obtained is generally very irregular. For example, the particles may be thread-like or leaf-like. They may become entangled during the movement. They do not form a smooth material cone. Practical use in many areas of industry thus becomes difficult.

Methods and devices in which the plastic provided as a starting material is liquefied by means of a solvent are also known. The solution obtained can be sprayed; generally, particles with a good spherical shape are formed. In that case, however, chemical solvents are being used that affect the environment; waste products are produced. The plastics may change chemically. The disclosure aims to make do without such solvents.

### SUMMARY

It is also the goal of the disclosure not to increase the fines content. Thus, the particles are not supposed to be disintegrated by the method. A disintegration would lead to a fines content that may be disadvantageous for the desired use because, for example, it may deposit on the lenses of the lasers and thus prevent an optimum printing result. Or an additional step for removing dust from the powder is required, which is laborious and results in a product loss in a range of, not infrequently, 10 to 20%.

The aim is medium grain sizes of less than 500, in particular less than 100 μm, e.g. particles in the range of 30 to 100 μm. The maximum upper limit that can be specified is 800 μm. A fine dust content, i.e. particles smaller than 45, 10 or 5 μm, for example, is also a goal; it is requested by the industry for various applications. Other customers want powders with grain distributions without this fine dust content.

Accordingly, the disclosure provides a device and a method with which a starting material of irregularly shaped plastic particles provided in pulverulent form can be converted into ones that are as spherical as possible.

As for the method, a method provides reshaping a starting material of pulverulent plastic particles into pulverulent plastic particles that are as spherical as possible, comprising the following method steps:
a) providing pulverulent plastic particles as a starting material,
b) heating the plastic particles in a first treatment chamber to a first temperature T1 below the melting point of the plastic, the first temperature T1 being determined such that the plastic particles do not yet stick together,
c) transferring a directed flow of the plastic particles thus heated into a second treatment chamber,
d) heating the plastic particles in the second treatment chamber to a second temperature T2 above the melting point of the plastic, and
e) cooling the plastic particles to a temperature below the first temperature T1.

With this method and the device, even particles in the shape of little bars, short fibers, sheet-like pieces, particles with elongate configurations and small tear threads, which are otherwise considered to be rather critical, can be reshaped into a spherical structure. In the process, the volume is largely maintained. Advantageously, only a superficial region is melted and reshaped, and the core of a particle remains in the solid state of aggregation as far as possible. Even materials containing glass fibers and carbon fibers can be rounded without shortening the fibers or destroying them by breaking them. The fibers do not become thermally soft and are reshaped because they generally have a significantly higher melting temperature than the plastic material. Dry blended powder/fiber mixtures may also be at least partially bonded by the method. A segregation in a subsequent process is thus prevented.

Advantageously, the method takes place in an enclosed space. The device has an enclosed housing in the shape of the first treatment chamber and the second treatment chamber, including the transition zone, which has openings that are suitable for feeding and for removing the finished product and can preferably be closed. The method may be carried out continuously or in batches. The spheronization is achieved exclusively thermally.

The disclosure substantially works in two stages. In a first stage, which is carried out in the first treatment chamber, the particles of the starting material are heated to the extent that they have a temperature slightly below the melting point of the plastic material. They are supposed not to have a sticky surface yet. They are provided with as much thermal energy as possible, so that only the heat energy required for at least melting a boundary region has to be supplied in the subsequent second step, which is carried out in the second treatment chamber. For polyamide 12, for instance, the melting temperature is 175 to 180° C., for example. In the first stage, particles of polyamide 12 are preferably heated only to 170° C. at most.

The particles are sticky only in the second step; here, they must be prevented from adhering somewhere or from coming into contact with and sticking to one another. Due to the abrupt cooling in the lower region of the second stage, the critical region within which the particles are reshaped and being sticky is limited in a downward direction. The upper limit of this critical region is delimited by the place in the second heating device at which the particles are additionally heated to the extent that they are sticky. The particles are not yet sticky in the transition between the first and second stages; they have yet to be supplied with heat energy by means of the second heating device. Preferably, the critical region is laterally delimited by a free space, a sheath flow and/or a preferably cylindrical wall. This wall may be formed, for example, as a cylinder or in a conical shape having glass or quartz. Preferably, the wall has means by which particles flying towards the wall are deflected or shaken off. For example, the wall is made to vibrate by means of ultrasound. In the z-direction, the critical region has the length d.

In the method, a plurality of particles is guided in a directed manner in a flow. In the process, the individual particles are not supposed to touch; the distances between the individual particles are selected so as to have a corresponding size. On the whole, the particles are supposed to behave like an ideal gas. The movement of the particle flow follows the flow of the gas in which the particles are located. This movement is preferably in the direction of gravitation.

The particles need not and should not be transferred completely into the liquid phase. It is sufficient if outer regions, e.g. 60 or 80% of the volume close to the surface, melt to such a sufficient extent that irregularities are compensated due to the surface tension. The core of a particle may remain untouched in the method. It is then surrounded by a reshaped layer which externally renders a body as spherical as possible. This is also gentle on the plastic material. Also, it is better and easier to carry out with respect to the energy. However, this does not preclude the particles from being completely transferred into the liquid phase. The temperature of the particles should remain above and as close as possible to the melting temperature, in particular 5° C. above it at most. For the example of polyamide 12, the temperature of the particles in the second stage is 175 to 180° C., for instance.

The method preferably takes place in an inert gas atmosphere, e.g. nitrogen. Preferably, the oxygen content is below the oxygen limit concentration at least in the second treatment chamber, preferably also in the first treatment chamber.

The pulverulent plastic material introduced into the device as the starting material may preferably be produced in a method as it is described in the German priority application of 19 Jan. 2017, with the file number 10 2017 100 981 by the same applicant. The content of the disclosure of that application belongs completely to the content of the disclosure of the present application.

### BRIEF DESCRIPTION OF THE DRAWINGS

Exemplary embodiments of the disclosure will be explained below and described in more detail with reference to the drawing. These exemplary embodiments are not to be understood as limiting. In the drawings:

FIG. 1 shows a first exemplary embodiment of the device in a schematic illustration,

FIG. 2 shows a second exemplary embodiment of the device, also in a schematic illustration,

FIG. 3 shows a perspective view of a partial region of a flow straightener in a first configuration, and

FIG. 4 shows a perspective view as in FIG. 3 in a second configuration.

### DETAILED DESCRIPTION OF THE DRAWINGS

A right-handed x-y-z coordinate system is used for the description. The z-axis extends upwards, contrary to the direction of gravity.

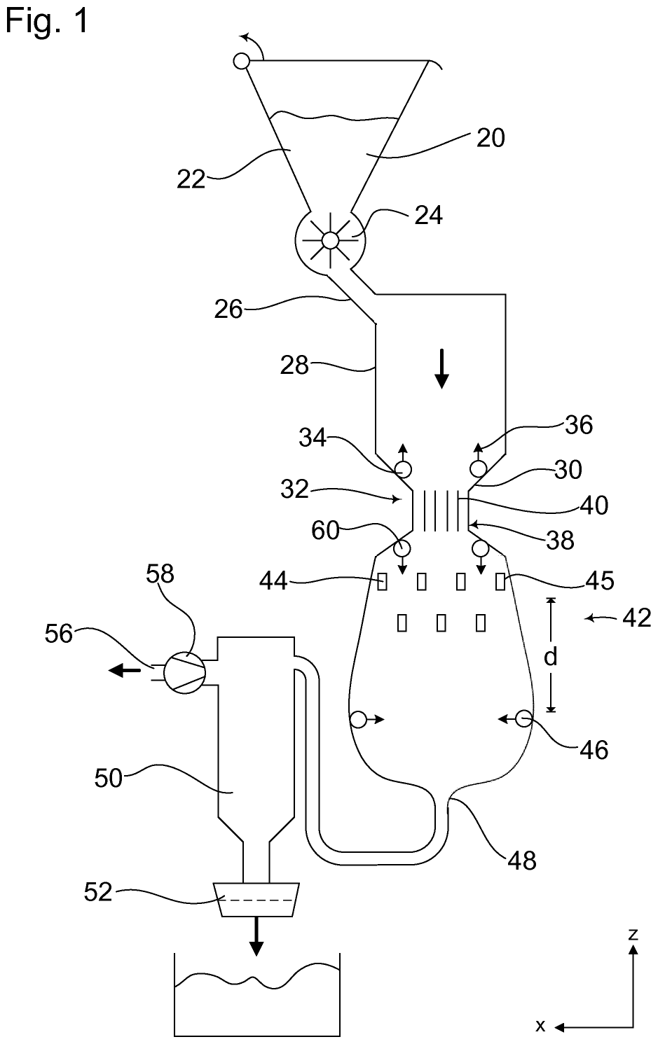

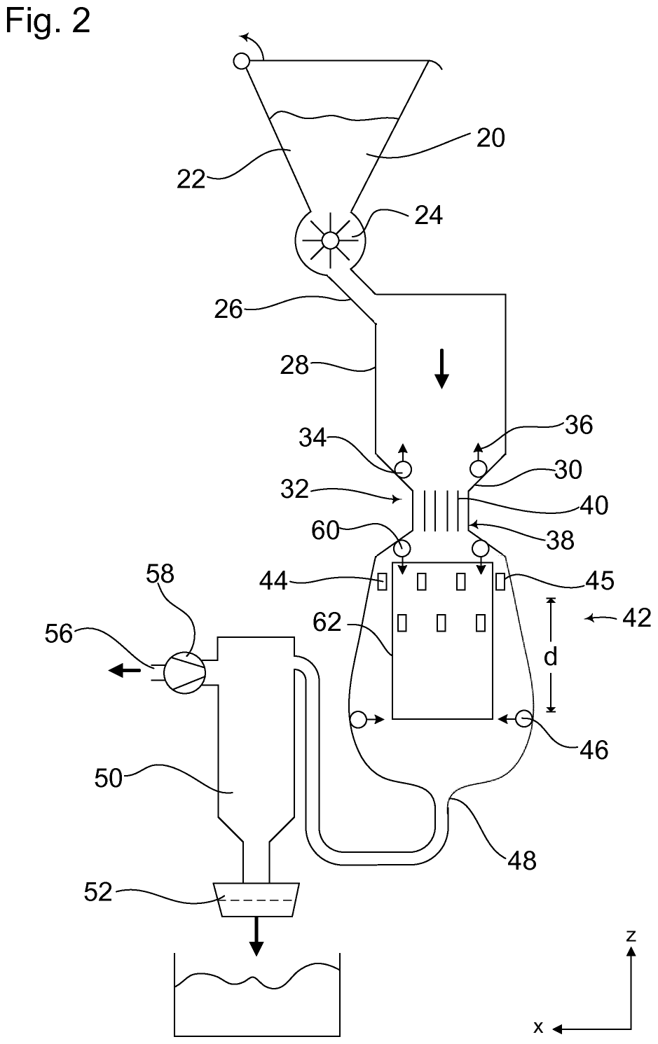

At first, the first exemplary embodiment according to FIG. 1 will be discussed below. Then, the second exemplary embodiment according to FIG. 2 will be discussed only to the extent it differs from the first exemplary embodiment.

Starting material 20 which has been crushed in a grinder (not shown), for example, has been filled into a bunker 22. The bunker 22 can be sealed in an air-tight manner; it has a corresponding lid. Preferably, it has a conical shape. A rotary feeder 24 is located at its lower end; its exit is connected to a product inlet 26 of a first treatment chamber 28. Rotary feeders 24 are known from the prior art; they are being used for the metered discharge from silos for powder and grain sizes of 0-8 mm. Reference is made, for example, to DE 31 26 696 C2.

The first treatment chamber 28 is formed to be substantially cylindrical, wherein the cylinder axis coincides with the z-direction. In its lower region, the first treatment chamber 28 tapers conically and has an outlet 30 there; there, it is connected with a transition zone 32. An annular inlet for hot air, which forms a first heating device 34, is located in the lower conical region. In the direction of the arrows 36, hot gas is blown into the first treatment chamber 28 in the z-direction. This hot gas heats up the starting material 20 located in the first treatment chamber 28 and brings it to a first temperature T1. The aim is that the individual particles of the starting material 20 are all, if possible, uniformly heated up to the first temperature T1 in the first treatment chamber 28.

It is also possible to configure the first heating device 34 differently. In this case, the injection of hot air is maintained, because hot air causes the particles to be transported. However, less hot air is blown in and, additionally, heat is supplied via a heating jacket (not shown) located on the cylindrical outer wall.

It is possible to already pre-heat the starting material 20 that is filled into the bunker 22. Any heating device as it is known from the prior art can be used for this purpose. The starting material 20 may be heated as bulk material. The pre-heating temperature is as high as possible, but below the melting point of the material to such a sufficient extent that there is no risk of the particles of the starting material 20 sticking together, even though they are in direct contact. It is possible to dispense with the first treatment chamber 28. This is the case particularly if a pre-heating process takes place.

The transition zone 32 is cylindrical. A flow straightener 38 is disposed in the transition zone 32. It fills the entire cross section of the tubular transition zone 32. It serves for making the movement of the particles in the negative z-direction uniform and do so in conjunction with the hot gas flow, which originates from the first heating device 34 and can only flow away via the flow straightener 38. The gas flow transports and carries the particles. A laminar flow is obtained by means of a suitable configuration of the flow straightener 38 and the flow of the gas. A directed particle flow is obtained which flows into a second treatment chamber 42 located below the transition zone 32. This particle flow is supposed to behave like an ideal gas. The particles are all supposed to move in a linear manner. They are supposed not to come into contact with one another.

The laminar flow is a movement of liquids and gases in which no visible turbulences (swirling/transverse flows) occur (yet): the fluid flows in layers that do not mix. Since a constant flow speed is maintained in the transition zone 32, this is a steady flow.

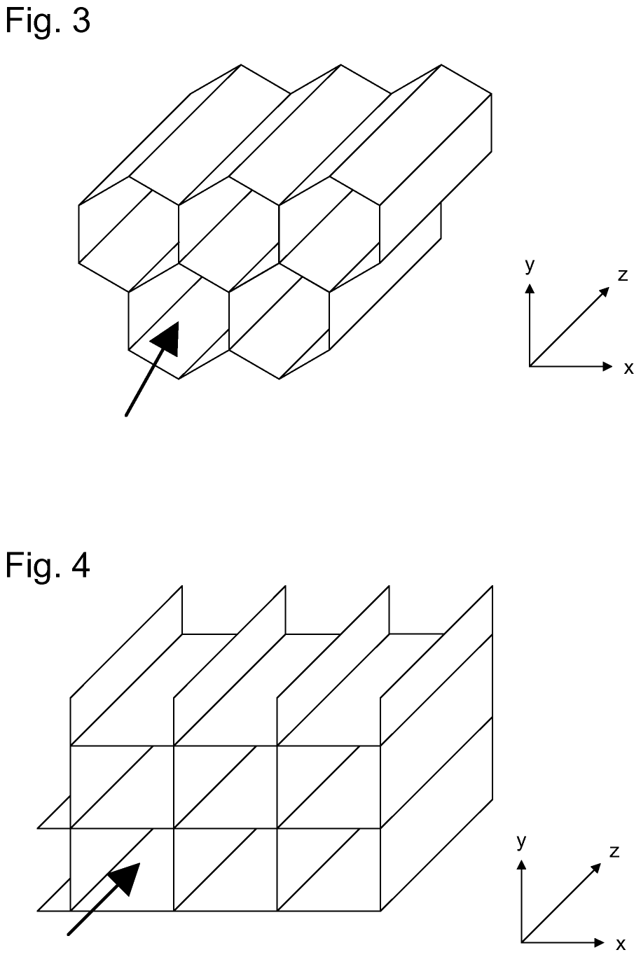

Flow straighteners 38 are known, for instance, from DE 10 2012 109 542 A1 and DE 10 2014 102 370 A1. FIGS. 3 and 4 show parts of two possible embodiments. In the embodiment according to FIG. 3, dividing walls 40 are arranged in such a way that they produce a honeycomb pattern in the x-y plane. In FIG. 4, the dividing walls 40 intersect at right angles and form a square grid in the x-y plane. In the z-direction, both embodiments extend over several centimeters, e.g. 5 to 15 cm. The clear distance of opposite dividing walls 40 in the x-y plane may be in the range of 0.5 to 5 cm.

A second treatment chamber 42 is located underneath the transition zone 32. With its upper region, it is connected to the lower end of the transition zone 32. It has a substantially cylindrical configuration. It includes a second heating device 44. In the specific exemplary embodiment, this is realized by means of a plurality of infrared radiators 45 located on the inner wall of the second treatment chamber 42. They can be individually controlled and individually temperature-regulated. In the x-y plane, they are sufficiently distant from the particle flow that particles can be prevented from ending up in their vicinity. They are directed towards the particle flow and are supposed to bring the particles to a second temperature T2, which is slightly above the melting temperature. Thus, the individual particles are melted at least in their superficial region; they become at least partially liquid. Due to the surface tension, these particles are deformed and assume a more or less spherical shape.

In the process, the particle flow flowing downwards needs to be able to freely pass through a sufficiently long distanced in the negative z-direction in order to provide the particles with enough time to be formed. The time-span required for the forming is determined by experiments for each plastic and the secondary conditions. The distance d is calculated from the time-span and the flow speed of the gas conveying the particles.

As long as the particles are at the second temperature T2, a contact of one particle with another particle must not occur, if possible, and the particles should not end up on the inner wall of the second treatment chamber 42 or contact another item. Since it is difficult in practice to keep the particle flow constant over the above-mentioned distance, in particular to keep the cross section constant, the second treatment chamber 42 expands conically in the downward direction, corresponding to an expansion of the flow in that direction.

If the particles are formed, they maintain their mass. Only the shape changes.

At the lower end of the distance d, the forming process has occurred to a sufficient extent, and a spherical shape has been obtained at least substantially. There, the particles in the lower region of the second treatment chamber 42 are cooled down to a temperature below the first temperature T1 as quickly as possible in a cooling zone, so that they are no longer sticky. Cooling takes place by introducing a cooling gas; preferably, liquid nitrogen is injected through nozzles 46 oriented transversely to the z-direction. The cooling zone is located below the distance d and ends above the bottom of the second treatment chamber 42. i.e. above the product outlet 48.

The particles, which are no longer sticky, are removed at the product outlet 48 located in the lowermost region of the second treatment chamber 42. In the process, they are being transported by the gas flow prevailing in the second treatment chamber 42. On the one hand, it has its source in the hot air from the first treatment chamber 28 and, on the other hand, in the pressure of the relaxing liquid nitrogen flowing from the nozzles 46. This gas flow can only escape through the product outlet 48.

A filter 50 is connected via a pipe to the product outlet 48. A screen 52 is located below this filter 50. The particles, which are now spherical, fall from the screen 52 into a collecting container 54, e.g. into a bag.

An outflow opening 56 for the gas of the flow described above is provided on the filter 50. It is possible to arrange a fan 58, which is controllable and capable of controlling the measure of the quantity of gas over time flowing out in this outflow opening 56.

An improvement is additionally drawn in in FIG. 1. Injection nozzles 60, whose outlets are orientated downwards, in the negative z-direction, are disposed in the second treatment chamber 42 and directly underneath the flow straightener 38, in the x-y plane outside the diameter of the flow straightener 38. Hot gas, which preferably has the temperature T2, is injected through them. It forms a sheath flow around the particle flow. The injection nozzles 60 for supplying heated hot gas may also be used for heating the particles to the second temperature T2, in addition to the infrared radiator 45, or also without them.

A cylindrical wall 62 is additionally disposed in the second treatment chamber 42 in the exemplary embodiment according to FIG. 2. It is preferably made from quartz glass and transparent to the light of the infrared radiators 45. It has an inner diameter slightly larger than the diameter of the injection nozzles 60. The sheath flow caused by the injection nozzle 60 is delimited towards the outside by this wall 62. The wall 62 has an upper end located laterally of or just below the injection nozzles 60. It has a lower end located above the nozzles 46.

The device preferably has a plurality of sensors, at least one of which is one of the sensors listed below:
Sensors for detecting at least one temperature in the first treatment chamber, in the second treatment chamber,
Sensors for detecting the temperature of the introduced hot gas,
Sensors for detecting the speed of the introduced hot gas,
   and it further has a control unit for controlling the process. These details are not depicted in the drawing.

Terms like substantially, preferably and the like and indications that may possibly be understood to be inexact are to be understood to mean that a deviation by plus/minus 5%, preferably plus/minus 2% and in particular plus/minus one percent from the normal value is possible. The applicant reserves the right to combine any features and even sub-features from the claims and/or any features and even partial features from the description with one another in any form, even outside of the features of independent claims.

1. A method for forming a starting material of pulverulent plastic particles into pulverulent plastic particles that are as spherical as possible, comprising the following method steps:
a) providing pulverulent plastic particles as a starting material,
b) heating the plastic particles in a first treatment chamber to a first temperature T1 below the melting point of the plastic, the first temperature T1 being determined such that the plastic particles do not stick together,
c) transferring a directed flow of the plastic particles heated into a second treatment chamber,
d) heating the plastic particles in the second treatment chamber to a second temperature T2 above the melting point of the plastic, and
e) cooling the plastic particles to a temperature below the first temperature T1.

2. The method according to claim 1, wherein in method step c), the flow of the plastic particles is converted into a laminar flow by a flow straightener.

3. The method according to claim 1, wherein the plastic particles do not come into contact with one another in the second treatment chamber.

4. The method according to claim 1, wherein the plastic particles in the second treatment chamber are situated in a directed flow and move in the negative z-direction under the influence of a gas flow and of gravitation.

5. The method according to claim 1, wherein the plastic particles of the starting material have at least a length that is at least 50% longer than the longest length of the final product of the pulverulent plastic particles that are as spherical as possible.

6. The method according to claim 1, wherein in the method step b), the first temperature T1 is at least 3° C. below the melting point of the plastic.

7. The method according to claim 1, wherein in the method step d), the second temperature T2 is at least 3° C. above the melting point of the plastic.

8. The method according to claim 1, wherein the plastic particles in the second treatment chamber execute a linear movement.

9. The method according to claim 1, wherein the plastic particles in the second treatment chamber are surrounded by a sheath flow that flows in the same direction and with the same speed as the flow of plastic particles in the negative z-direction.

10. The method according to claim 1, wherein the oxygen content is below the oxygen limit concentration at least in the second treatment chamber.

11. The method according to claim 1, wherein the plastic particles of the starting material are individually injected into the first treatment chamber and/or the second treatment chamber.

12. The method according to claim 1, wherein the plastic particles of the starting material, in step a), are already being heated to a pre-heating temperature significantly below the first temperature T1.

13. A device for carrying out the method according to claim 1, wherein the device comprises:
a first treatment chamber having a product inlet for the starting material and an outlet, and which further has a first heating device,
a transition zone connected at one end to the outlet,
a second treatment chamber which, in its upper region, is connected to the other end of the transition zone, which has a second heating device, which has a cooling zone located underneath the second heating device, and has a product outlet.

14. The device according to claim 13, wherein the product inlet is connected to a bunker in which the starting material is located and configured to be sealed to be air-tight, wherein a rotary feeder is located between the bunker and the first treatment chamber.

15. The device according to claim 13, wherein a filter and a screen, in this order, are disposed on the product outlet.

16. The device according to claim 13, wherein the first heating device of the first treatment chamber has an injection device for introducing heated hot gas.

17. The device according to claim 13, wherein the second heating device has a number of heating elements arranged transversely to the z-axis.

18. The device according to claim 13, wherein the second treatment chamber has a container that expands in the negative z-direction.

19. The device according to claim 13, wherein a suction fan is disposed on the product outlet.

20. The device according to claim 13, wherein a wall is disposed in the second treatment chamber, wherein the wall extends parallel to the z-direction and has an upper end located above the second heating device, and has a lower end located above the nozzles.
